(19) United States
(12) Patent Application Publication
(10) Pub. No.: US 2012/0126535 A1
(43) Pub. Date: May 24, 2012

(54) PIPE COUPLING DEVICE

(75) Inventor: Craig Stanners, Cheshire (GB)

(73) Assignee: STANNSEAL LTD., Cheshire (GB)

(21) Appl. No.: 13/322,855

(22) PCT Filed: May 21, 2010
(86) PCT No.: PCT/GB2010/001016

§ 371 Date: Feb. 13, 2012

(30) Foreign Application Priority Data
May 28, 2009 (GB) 0909216.4

(51) Int. Cl. F16L 37/08

(52) U.S. Cl. 285/421

(57) ABSTRACT

A pipe coupling device for coupling flanged pipes includes a housing having first and second sections movable relative to one another between an open position and a closed position, said first and second sections each adapted to receive a portion of respective flanges of a pair of pipes to be coupled; fastening means for fastening the first and second sections around the flanges; and urging means adapted to be disposed in the housing with the flanges and to urge the flanges together as the first and second sections are closed around the flanges.

### RELATED APPLICATIONS

The present application is a National Phase entry of PCT Application No. PCT/GB2010/001016, filed May 21, 2010, which claims priority from Great Britain Application Number 0909216.4, filed May 28, 2009, the disclosures of which are hereby incorporated by reference herein in their entirety.

### TECHNICAL FIELD

This present invention relates to a pipe coupling device for pipes. The pipes may be used in the water, oil, marine, industrial, gas or sewage industry, for example.

### BACKGROUND

Conventionally, flanged pipes are joined together by aligning and abutting the respective flanges of each pipe, inserting threaded bolts through holes provided in each flange and securing the flanges together with nuts. A washer or inner seal is generally provided between the two abutting flanges to obtain a fluid-tight seal. FIG. 1 shows such flanges joined together. Two pipes 1 are to be joined together via their respective flanges 2. A washer or inner seal, not shown, is inserted between the two flanges. The holes 3 in the flanges 2 of each pipe 1 must be aligned. Threaded bolts are then inserted through the holes and secured by nuts at each end of each bolt. Thus the two pipes are joined together in a fluid-tight manner.

A problem with conventional couplings is that they require the alignment of the two sets of holes of the respective flanges which may be time-consuming and may thus even require at least two people to provide the join between the pipes, one to hold the respective ends of the two pipes together, the other to insert and secure the bolts. The nuts must also be screwed onto the bolts such that alternate ends of the flanges in a radial direction are secured together to prevent undue stresses developing on the flanges. One may, for example, start at the uppermost holes and then proceed to join together the lowermost. Next, the holes which are removed from the uppermost and lowermost holes by 90° may be joined together. Subsequently, the remaining holes are provided with bolts and secured with the nuts.

This process may be very time consuming, particularly for large diameter pipes having a large number of holes, often taking a matter of hours to connect two sections of pipe together. Moreover, any or all of the large number of bolts may rust and/or stick after the pipes have been connected, making it extremely difficult subsequently to disconnect the pipes.

Often such pipes need to be joined together in confined spaces underground, and/or the pipes must be used for high pressure and/or hazardous applications, thereby exacerbating the problems associated with conventional couplings and further increasing difficulties arising from incorrectly coupled sections of pipes.

### SUMMARY

An object of the invention is to provide a pipe coupling device suitable for joining two abutting pipes via their flanges that alleviates the problems mentioned above.

According to an embodiment, there is provided a pipe coupling device for coupling flanged pipes comprising: a housing having first and second sections movable relative to one another between an open position and a closed position, said first and second sections each adapted to receive a portion of respective flanges of a pair of pipes to be coupled; fastening means for fastening the first and second sections around the flanges; and urging means adapted to be disposed in the housing with the flanges and to urge the flanges together as the first and second sections are closed around the flanges.

In one embodiment, as the first and second sections are closed, the urging member transmits the closing force in a direction orthogonal to the direction of closing by way of abutment, whereby at least one said flange is urged towards another.

In one embodiment, the first and second sections are pivotally connected at one end and fastenable in the closed position at another end.

In one embodiment, the first and second sections each comprise a receptacle for a portion of each said flange, each said receptacle comprising two opposed side walls.

In one arrangement that the inner surfaces of the two side walls are substantially parallel to each other.

In another arrangement, the inner surface of one of the two side walls is angled with respect to the other such that the distance between the inner surfaces of the two side walls increases with distance away from the outer perimeter of the housing.

In one embodiment, the urging means comprises opposed first and second side surfaces extending in a direction between inner and outer surfaces, one of the side surfaces being angled with respect to the other such that the thickness of the urging means decreases with distance from the inner surface of the urging means.

In one embodiment, the urging means comprises at least one substantially half annulus member.

In this case, said annulus member can have an increased thickness towards its inner surface.

In one arrangement, the urging means comprises a substantially half annulus member provided with a shoulder on its outer perimeter.

In another arrangement, the urging means comprises a substantially half annulus member provided with a concave surface so as to define an arc in cross-section.

In one arrangement, a said side wall has a slant shape and the urging means has an inverse slant shape, whereby, as the urging means moves relative to the slanted side wall towards the outer perimeter of the housing, the distance between the urging means and the other said side wall decreases.

The urging means can be provided with a shoulder on its outer perimeter adapted to engage with a perimeter of one of the flanges.

According to an embodiment, there is provided a pipe clamping means adapted to fit around the perimeter of the flanges of two adjacent pipes which are to be attached, said clamping means forming a seal between said pipes and comprising: urging means to urge the two flanges together when the clamping means is closed around the flanges.

According to an embodiment, there is provided a housing for a pipe coupling device as set out above, comprising: first and second sections movable relative to one another between an open position and a closed position, said first and second sections each adapted to receive a portion of respective flanges of a pair of pipes to be coupled; and fastening means for fastening the first and sections around the flanges; wherein said first and second sections are adapted to interact with urging means intended to be disposed in the housing with the flanges and to urge the flanges together as the first and second sections are closed around the flanges.

It can be advantageous in an embodiment that, as the first and second sections are closed, the urging member transmits the closing force in a direction orthogonal to the direction of closing by way of abutment, whereby at least one said flange is urged towards another.

It can also be advantageous that the first and second sections are pivotally connected at one end and fastenable in the closed position at another end.

It can also be advantageous that the first and second sections each comprise a receptacle for a portion of each said flange, each said receptacle comprising two opposed side walls; and the inner surface of one of the two side walls is angled with respect to the other such that the distance between the two side walls increases away from the outer perimeter of the housing.

According to an embodiment, there is provided urging means for a pipe coupling device as set out above, wherein the urging means comprises opposed first and second side surfaces extending in a direction between inner and outer surfaces, one of the side surfaces being angled with respect to the other such that the thickness of the urging means decreases with distance from the inner surface of the urging means.

In one embodiment the urging means comprises at least one substantially half annulus member.

In one embodiment, the urging means comprises a substantially half annulus member provided with a shoulder on its outer perimeter.

Alternatively, it can be advantageous that the urging means comprises a substantially half annulus member provided with a concave surface such as to define an arc in cross-section.

The urging means can be provided with a shoulder on its outer perimeter adapted to engage with a perimeter of one of the flanges.

### BRIEF DESCRIPTION OF THE DRAWINGS

Embodiments of the invention will now be described by way of further example only and with reference to the accompanying drawings, in which:

FIG. 1 is a perspective view of a pipe coupling of a conventional type.

FIG. 2 is a plan view of the pipe coupling device housing according to an embodiment.

FIG. 3 is a perspective view of one part of the housing according to an embodiment.

FIG. 4 is a plan view of pipe coupling device urging members according to an embodiment.

FIG. 5 is a cross-sectional view of a pipe coupling device urging member according to an embodiment.

FIG. 6 is a partial cross-sectional view of a pipe coupling assembly according to the an embodiment, in which pipe flanges and a device urging member according to one embodiment are being inserted into the housing.

FIG. 7 is a partial cross-sectional view of the pipe coupling assembly in its final position.

FIG. 8 is a partial cross-sectional view of a pipe coupling assembly using a device urging member according to an embodiment.

FIG. 9 is a partial cross-sectional view of a pipe coupling assembly using a device urging member according to an embodiment.

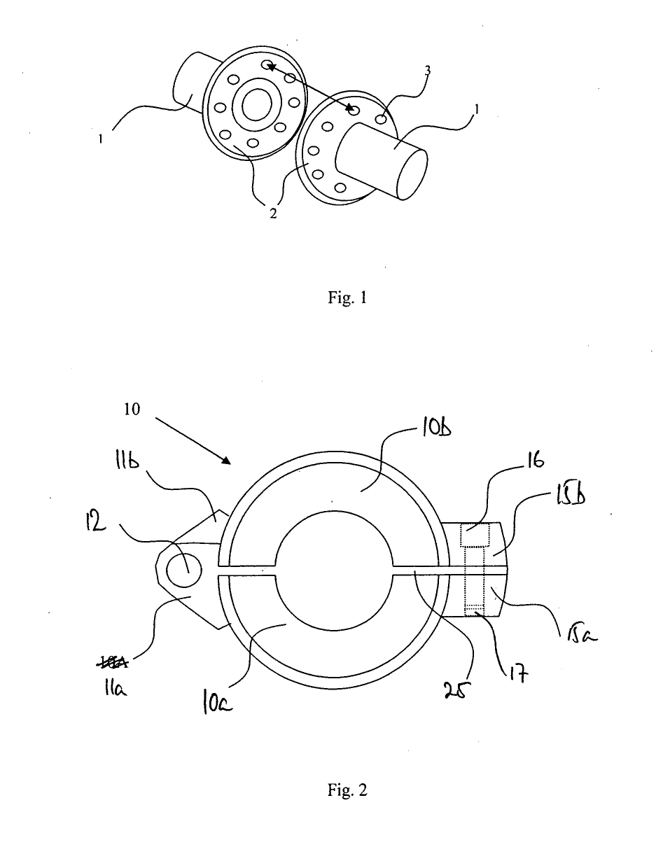

### DETAILED DESCRIPTION

FIG. 2 is a plan view showing a housing according to an embodiment, in the closed position. The housing, generally designated 10, comprises two sections 10a, 10b each having a hinge portion 11a, 11b. The two sections 10a, 10b are joined together at the hinge portions 11a, 11b using a hinge pin 12. This allows the housing sections 10a, 10b to define an open position and a closed position. Opposite the hinge portions 11a, 11b, each section 10a, 10b is provided with a clamp portion 15a, 15b. A bolt 16 and nut 17 are used to lock the two sections 10a, 10b in the closed, coupling position. In fact, it is preferred that a swing bolt arrangement is used as the fastening mechanism, although any other suitable fastening arrangement can be used.

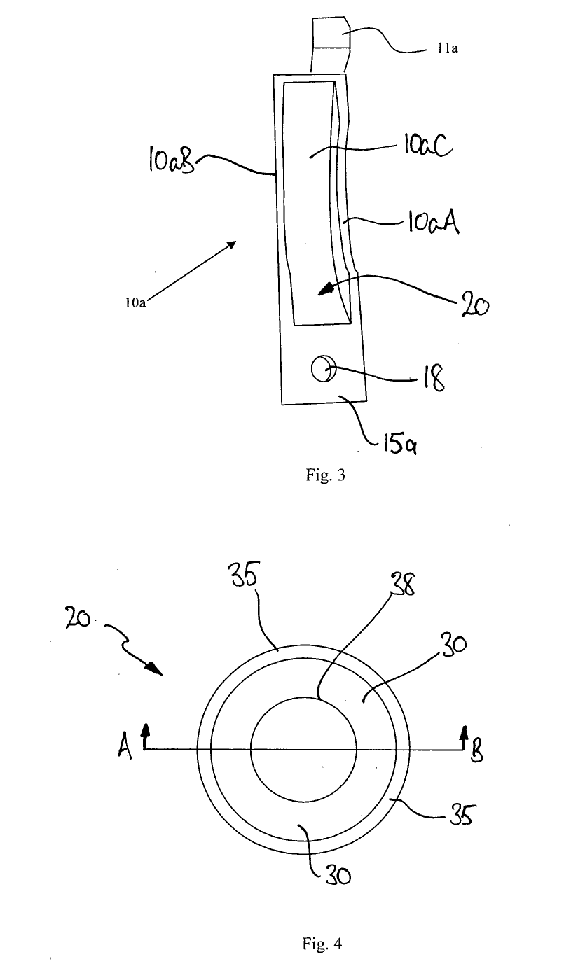

FIG. 3 is a perspective view of section 10a of the housing 10, separated from section 10b. As can be seen, the housing section 10a has a cavity 20, which is defined by two side walls 10aA, 10aB and a bottom curved wall 10aC (see FIG. 6) and is formed between the hinge portion 11a and the clamp portion 15a. Note that in this embodiment a bolt hole 18 is provided to receive the clamping bolt 16.

The cavity 20 is a receptacle shaped so as to be able to receive substantially one half of each of the respective flanges of two pipes to be joined together. The other section 10b is similarly formed and includes a cavity 20 for receiving substantially the other half of each of the respective flanges of two pipes to be joined together. In use, housing 10 is placed in the open position and the housing and/or respective flanges of pipes to be coupled (preferably with a washer or seal between them) are manoeuvred so that part of the flanges lies within the cavity 20 of one of the housing sections 10a, 10b. Subsequently the housing sections 10a, 10b are pivoted with respect to one another about the hinge pin 12 so that the housing 10 encompasses substantially the entire circumference of the flanges. Note, however, that in the present embodiment a gap 25 is provided to account for manufacturing tolerances and to ensure that a tight seal can always be provided, for reasons that will become apparent to the skilled addressee from the subsequent description. The size and diameter of the housing 10 will vary dependent on the size of the flanges being coupled together and the size of the gap 25 will vary accordingly. Typically, however, a size of gap 25 according to an embodiment is 4 mm.

Once the housing 10 is in place encompassing the flanges of the two abutting pipes, it can be fastened in the closed position using the bolt 16 or other suitable locking means (such as a swing bolt).

Further details of the housing 10 are shown in, and will be described later with reference to, FIG. 6.

FIG. 4 is a plan view of two urging members 30, together forming an annulus, according to the first embodiment that are positioned in the housing 10 together with the flanges and are adapted to urge the two flanges together. More specifically, as will become apparent from the subsequent description, each urging member 30 is inserted between one of the two side walls of at least one of the housing sections 10a, 10b on one hand and the outer surface of the one of the flanges on the other hand. Usually two urging members are provided in the housing, one in each section of the housing. However, it is not always necessary to provide two urging members 30 or for an urging member 30 to be provided in solely in one housing section 10a, 10b (rather, an urging member 30 may straddle the two housing sections 10a, 10b) and embodiments are not limited thereto.

Two urging members 30 are usually machined together as a disc 20, as shown in plan view in FIG. 4, and then a cut is made along line AB to provide the separate urging members 30. This allows for a more time efficient and cost effective method of manufacture of the urging members 30.

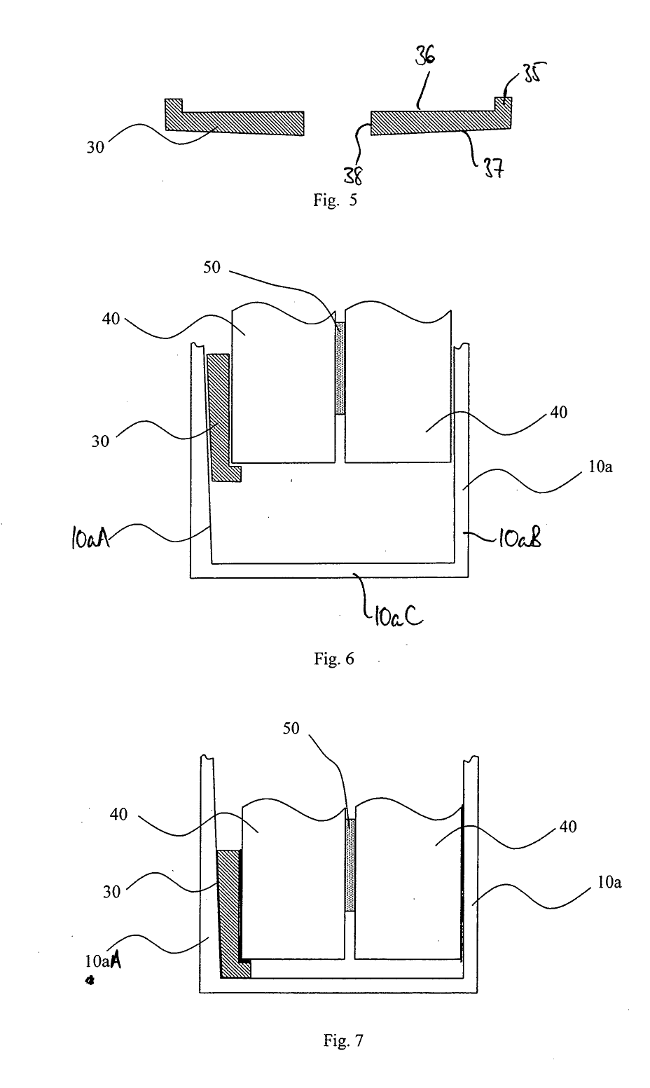

FIG. 5 shows an urging member 30 according to a first embodiment in cross-section about the line A-B in FIG. 4. As can been seen, each urging member 30 includes an inner perimeter 38, a housing side surface 37, a flange side surface 36, and a shoulder 35 provided at the outer perimeter. The shoulder 35 is adapted to engage with the outer perimeter of at least one of the flanges of the two pipes to be coupled, although it may extend sufficiently in the pipe axial direction to engage with both flanges to assist relative positioning of the two flanges. In the present embodiment, the thickness of the urging member increases with distance from the outer perimeter to the inner perimeter 38.

FIG. 6 is a partial cross-section showing an urging member 30 according to the first embodiment being inserted into one section 10a of the housing 10 together with two flanges 40 of respective pipes to be coupled and an O-ring or gasket seal 50 between the two flanges. In this example, although not shown, the two flanges are also inserted into the cavity 20 of the other housing section 10b with another urging member 30 as the two housing sections 10a, 10b are brought together in the closed position. It is not always necessary to provide the inner seal 50. However, it can assist to provide a fluid-tight seal and is likely to be a requirement in some applications. The inner seal 50 can be comprised of neoprene, EPDM, nitrile or any other suitable material.

In this embodiment, in contrast with the urging members 30, the thickness of one of side walls 10aA of the housing section 10a decreases with distance from the outer perimeter to the inner perimeter 38 so that the side wall 10aA is angled away from the other side wall. This makes the distance between the two side walls greater towards the open end of the cavity 20 of the housing section.

The urging member 30 in this embodiment has a substantially half annulus shape provided with a shoulder 35 at its outer perimeter, as discussed above. The shoulder 35 is brought into contact with the outer perimeter of one of the two flanges 40. The two abutting flanges 40 (such as with seal 50 therebetween) and the urging member 30 are then inserted into the housing 10. As the housing 10 is closed around the flanges 40, the flanges 40 and the urging member 30 are forced further into the housing 10.

FIG. 7 shows the urging member 30 and the flanges 40 inserted inside the housing section 10. The housing section side wall 10aA is angled away from the opposite wall as described above. The angled side wall 10aA is slanted to become thicker towards the outer perimeter and the urging member 30 is slanted to become thicker towards the inner perimeter. Thus, they are slanted in opposite directions. The housing 10 accommodates the portion of angled urging member 30 which is greatest in thickness at its inner perimeter, the inner perimeter being distal to the bottom wall 10aC of the housing section 10.

As the housing 10 is closed, the moving abutment of the housing-side wall 37 of the urging member 30 against the inner surface of the housing section side wall 10aA causes the urging member 30 to urge the flanges 40 in the longitudinal direction of the pipes/in a direction orthogonal to the closing direction of the housing 10. Specifically, due to the complementary angled surfaces of the housing section side wall 10aA and the housing-side wall 37 of the urging member 30, as the housing 10 closes and the urging member moves towards the bottom wall 10aC, the combined thickness of the housing section side wall 10aA and the urging member 30 increases, thereby narrowing the distance between the urging member 30 and the other housing section side wall 10aB. The right hand flange 40 in FIGS. 6 and 7 abuts the other housing section side wall 10aB. Thus, as the housing 10 closes, the flanges 40 are urged in the right hand direction in the figures and are forced together. This compresses the O-ring or gasket 50 to provide a fluid-tight seal and connection between the pipes.

The gap 25 allows sufficient tolerance to ensure that the two housing sections 10a, 10b can always be brought close enough together to force a fluid tight seal. Where a seal 50 having a degree of elasticity is provided, the components are manufactured with a tolerance to ensure that the seal is sufficiently compressed. If the seal 50 has elasticity, the elasticity can allow the housing 10, urging members 30 and flanges 40 to be manufactured with greater tolerances.

FIG. 7 shows the urging member 30 abutting each of the flange 40, housing section side wall 10aA and the bottom wall 10aC. However, it should be appreciated that abutment with the bottom wall 10aC is not necessary and a sufficient sealing force can be generated before abutment with the bottom wall 10aC is reached.

In a modification, the urging members 30 can be made of a comparatively stiff material and be slightly bowed in the axial direction (orthogonal to the closing direction of the housing 10). The bowed portion is straightened by the urging force, thereby providing a degree of elasticity in the urging member 30. This can allow a minimal degree of movement of the flanges in the axial direction of the flanges and pipes. This beneficial to allow, for example, for ground movement or subsidence in the case the pipes are buried underground. In this case, the elasticity of the seal may can maintain fluid tightness.

The housing sections 10a, 10b and the urging member 30 can be made of, for example: ductile iron; cast iron; mild steel; galvanised steel; stainless steel 304 and 316; aluminium; plastic; zinc; titanium; and brass. Embodiments are not limited to these materials and other suitable materials may be used.

A coating can be provided on the housing sections 10a, 10b and the urging member 30, for protection, for example, against water, oils or other substance that the coupling device may come into contact with. Suitable coatings include: epoxy; plascoat; scotch, etc.

The joints, including the hinges and fastening means can be made of any of the materials that the housing is made of.

It will be apparent that embodiments provide a particularly simple mechanism to couple pipes. In particular, the embodiments make it a simple matter for a workman, working by himself, to couple to sections of pipe together. In particular, there is no need to accurately marry bolt holes on the two flanges or to tighten a large number of nuts in a particular order. Indeed the bolt holes on the flanges can be done away with entirely, although their presence is not a hindrance to the functioning of embodiments, which can therefore be used on existing pipes with no adaptation. Accordingly, the work of joining pipes together can be performed very efficiently, therefore allowing considerable savings in man power. Moreover, the embodiments allow the coupling of pipes in enclosed spaces to be performed very much more simply and quickly and significantly reduce the present problems associated with nuts and bolts rusting together. Embodiments have been found to be particularly effective in practice up to pressures as high as a 60 bar test pressure and a working pressure of 40 bar and is suitable for use in the most taxing environments.

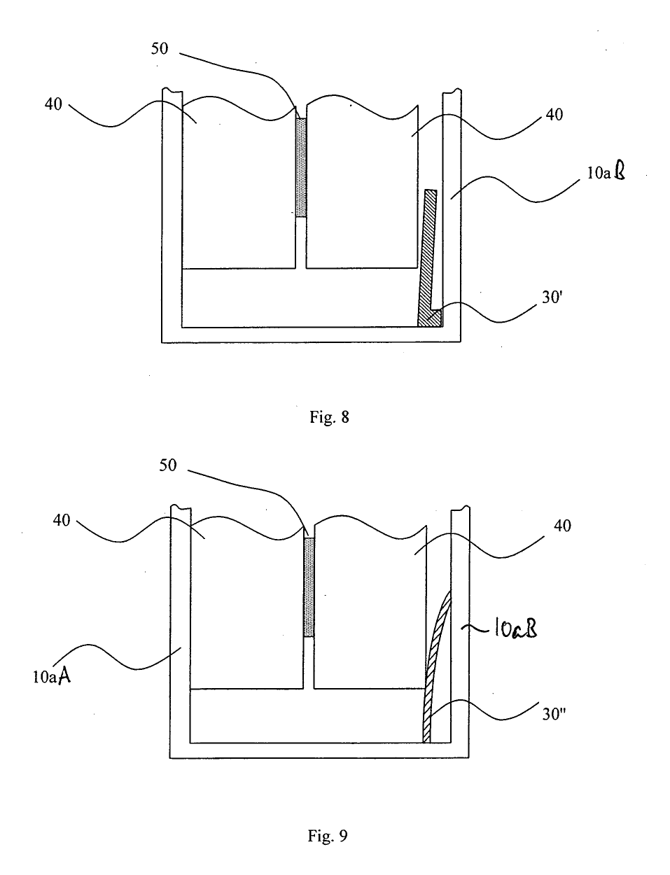

FIG. 8 shows a second embodiment. In this figure, the side walls of the housing 10 have a constant thickness, although one or both can be angled as in the first embodiment. The urging means 30′ according to the second embodiment will still urge the two flanges together even if the housing section side walls are not parallel to each other. The urging member 30′ again has a half annulus shape provided with a shoulder at its outer perimeter. The shoulder in this embodiment is not for engagement with the flanges 40. Rather, the shoulder abuts against one the two side walls of the housing section. In this embodiment the urging member 30′ is advantageously inserted into the housing 10 before the flanges 40 (as indeed it can be in the first embodiment). The urging member 30′ can be angled slightly towards the side walls, which enables the flanges 40 to be inserted with ease past the urging member 12. The urging member 12 is slightly elastic in embodiments and urges the flanges 40 towards each other thus ensuring a tight seal of the flanges. Increasing or decreasing the length of the shoulder of the urging member 30′ in the radial direction ensures that different thicknesses of flanges can be easily accommodated. The slight elasticity of the urging member also enables a slight movement of the flanges in the axial direction of the flanges, which can be useful to accommodate small shifts in the earth and small amounts of subsidence for pipes buried underground.

FIG. 9 shows a third embodiment. In this embodiment, as in the second embodiment, the side walls of the housing 10 have a constant thickness, although one or both can be angled as in the first embodiment. Again, the urging member 30″ according to the third embodiment can be used in a housing section where the two side walls are not parallel to each other. The urging member 30″ is again a half annulus shape. However, in this embodiment, the urging member 30″ is not provided with a shoulder, although in other embodiments it can be. If a shoulder is provided, it can be provided as in either the first or second embodiments. The urging member 30″ is substantially concave in cross-section such that the urging member 30″ is spaced apart from the side wall 10aB of the housing section 10 towards the bottom wall of the housing section. The shape of the urging member 30″ enables the housing sections to be closed around the flanges with ease. The urging member 30″ is again made of a material which has a slight elasticity which enables the urging member to urge the two flanges together to form a tight seal. The curvature of the urging member can enable different thicknesses of flanges to be accommodated in the same housing section.

It will be apparent that various different shapes and sizes of urging member 30 can be provided. However, in embodiments the urging members take the form of shims. Moreover, urging members 30 of a single size can be appropriate to accommodate flanges 40 of different sizes and to be housed on housings 10 of different sizes. Similar considerations apply in respect of the housing 10. Of course, the dimensions of the housing 10 and the urging members 30 can be varied depending on the sizes of the pipes to be coupled and the sizes of their flanges.

In the foregoing, the use of two urging members 30 at a time has been described. However, it is possible to couple pipes using one, two or more urging members. It can be advantageous that the urging members are arcuate, although other shapes will be apparent to those skilled in the art and are encompassed within embodiments. Thus, in embodiments each of the urging members has the shape of an arc of an annulus—that is, they are annular arc-shaped. It is also noted that the urging members 30 can, but need not, form a whole circle when placed together, even when two or more urging members are used. Moreover, although the urging members 30 shown in FIG. 4 form a circle when placed next to one another, it is expected that there will be a gap between them in use for the reasons explained above in respect of the housing 10. Such urging members could be said to be included within the scope of the term “substantially half annulus members”. Of course, embodiments encompass the situation where there are two substantially half annulus members or one such member and two other members.

Although all the figures show the flanges with an inner seal therebetween, the inner seal can be omitted if required.

Moreover, although both the side wall 10aA and the urging member 30 in the arrangement shown in FIGS. 6 & 7 have varying thickness, it is sufficient to provide only one of them with varying thickness. However, the arrangement shown in FIGS. 6 & 7 can be advantageous since it allows the urging force to be applied against a larger surface area of the flange 40 and more substantially in the direction orthogonal to the closing direction/more substantially in the axial direction of the housing, thereby providing a more reliable seal.

As noted above, it can be advantageous that the two housing sections 10a, 10b are fastened using a swing bolt mechanism. However, other suitable arrangements will be apparent to those skilled in the art. For example, a lever clip similar to that used on preservative jars can be used.

In the foregoing, the urging member 30, 30′, 30″ is shown in direct contact with the side wall 10aA. However, they need not abut each other directly but can abut indirectly. For example, a PTFE or other sheet can be provided between them in FIGS. 6 & 7 to allow them to slide smoothly over one another. Similarly, the components can be coated with coatings (eg a PTFE coating) to provide this functionality. Other intervening bodies can be provided in other portions of the arrangement, for example between the flange 40 and the side wall 10aB, and where two bodies are described as abutting in this specification, it is to be understood that this includes intervening bodies arranged therebetween.

It is to be noted that where components are described as moving, movement relative to other components is intended. Thus, where the urging member is described as moving towards the curved wall 10aC, relative movement between them is to be inferred, including at least some or only movement by the curved wall 10aC.

The housing sections 10a, 10b have been described as being joined using a hinge pin. However, other means of joining them are feasible, including the use of a nut and bolt or swing bolt, or a clip.

The walls of the cavity/receptacle 20 have been illustrated as solid continuous walls. However, they need not be. All that is required is for there to be a sufficient surface for the flanges and urging member(s) to abut. Thus, the side walls of each housing section can be joined by a plurality of struts, thereby doing away with the curved bottom wall 10aC. In any event, it can be advantageous that at least some provision is made in the receptacle/cavity 20 for drainage of rain or ground water.

The foregoing description has been given by way of example only and it will be appreciated by a person skilled in the art that modifications can be made without departing from the spirit and scope of the present invention.

1. A pipe coupling device for coupling flanged pipes comprising:
a housing having first and second sections movable relative to one another between an open position and a closed position, said first and second sections each adapted to receive a portion of respective flanges of a pair of pipes to be coupled;
fastening means for fastening the first and second sections around the flanges; and
urging means adapted to be disposed in the housing with the flanges and to urge the flanges together as the first and second sections are closed around the flanges, wherein the urging means comprises at least two annular arc-shaped members.

2. A pipe coupling device according to claim 1, wherein, as the first and second sections are closed, the urging members means transmit the closing force in a direction orthogonal to the direction of closing by way of abutment, whereby at least one said flange is urged towards another.

3. A pipe coupling device according to claim 1, wherein the first and second sections are pivotally connected at one end and fastenable in the closed position at another end.

4. A pipe coupling device according to claim 1, wherein the first and second sections each comprise a receptacle for a portion of each said flange, each said receptacle comprising two opposed side walls.

5. A pipe coupling according to claim 4, wherein the inner surfaces of the two side walls are substantially parallel to each other.

6. A pipe coupling according to claim 4, wherein the inner surface of one of the two side walls is angled with respect to the other such that the distance between the inner surfaces of the two side walls increases with distance away from the outer perimeter of the housing.

7. A pipe coupling device according to claim 1, wherein each of the urging means comprises opposed first and second side surfaces extending in a direction between inner and outer surfaces, one of the side surfaces being angled with respect to the other such that the thickness of the urging means decreases with distance from the inner surface of the urging means.

8. A pipe coupling device according to claim 1, wherein at least one of said annular arc-shaped members is a substantially half annulus member.

9. A pipe coupling device according to claim 8, wherein at least one of said annular arc-shaped members has an increased thickness towards its inner surface.

10. A pipe coupling device according to claim 1, wherein at least one of said annular arc-shaped members is provided with a shoulder on its outer perimeter.

11. A pipe coupling device according to claim 1, wherein at least one of said annular arc-shaped members is provided with a concave surface so as to define an arc in cross-section.

12. A pipe coupling device according to claim 4, wherein a said side wall has a slant shape and the urging means has an inverse slant shape, whereby, as the urging means moves relative to the slanted side wall towards the outer perimeter of the housing, the distance between the urging means and the other said side wall decreases.

13. A pipe coupling device according to claim 1, wherein the urging means is provided with a shoulder on its outer perimeter adapted to engage with a perimeter of one of the flanges.

14. A housing for a pipe coupling device according to claim 1, comprising:
first and second sections movable relative to one another between an open position and a closed position, said first and second sections each adapted to receive a portion of respective flanges of a pair of pipes to be coupled; and
fastening means for fastening the first and sections around the flanges;
wherein said first and second sections are adapted to interact with urging means comprising at least two annular arc-shaped members intended to be disposed in the housing with the flanges and to urge the flanges together as the first and second sections are closed around the flanges.

15. A housing according to claim 14, wherein, as the first and second sections are closed, the urging member transmits the closing force in a direction orthogonal to the direction of closing by way of abutment, whereby at least one said flange is urged towards another.

16. A housing according to claim 14, wherein the first and second sections are pivotally connected at one end and fastenable in the closed position at another end.

17. A housing according to claim 14, wherein:
the first and second sections each comprise a receptacle for a portion of each said flange, each said receptacle comprising two opposed side walls; and
the inner surface of one of the two side walls is angled with respect to the other such that the distance between the two side walls increases away from the outer perimeter of the housing.

18. Urging means for a pipe coupling device according to claim 1, wherein the urging means comprises at least two annular arc-shaped members, each said member having opposed first and second side surfaces extending in a direction between inner and outer surfaces, one of the side surfaces being angled with respect to the other such that the thickness of the urging means decreases with distance from the inner surface of the urging means.

19. Urging means according to claim 18, wherein at least one of said annular arc-shaped members is a substantially half annulus member.

20. Urging means for a pipe coupling device according to claim 1, wherein at least one of said annular arc-shaped members comprises a substantially half annulus member provided with a shoulder on its outer perimeter.

21. Urging means according to claim 18, wherein at least one of said annular arc-shaped members comprises a substantially half annulus member provided with a concave surface such as to define an arc in cross-section.

22. Urging means according to claim 18, wherein at least one of said annular arc-shaped members is provided with a shoulder on its outer perimeter adapted to engage with a perimeter of one of the flanges.
